(19) United States
(12) Patent Application Publication
(10) Pub. No.: US 2006/0095891 A1
(43) Pub. Date: May 4, 2006

(54) Scheduling software

(75) Inventors: Christopher Tofts, Bristol (GB); Richard Taylor, Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: HEWLETT-PACKARD DEVELOPMENT COMPANY, L.P., Houston, TX (US)

(21) Appl. No.: 11/259,200

(22) Filed: Oct. 27, 2005

(30) Foreign Application Priority Data
Oct. 29, 2004 (GB) 0424130.3

(51) Int. Cl. G06F 9/44

(52) U.S. Cl. 717/100

(57) ABSTRACT

Scheduling software is disclosed which is adapted to: receive input data sets for each of a plurality of tasks, each data set including a value for a resource required to perform the task and a rule relating to performance of the task; having regard to the rules in the data sets, order tasks in accordance with one or more predetermined criteria; calculate, using each of the values for the resource from individual tasks, a value for a parameter of the resource, wherein the value is calculated upon the basis of a function which is an algebra homomorphism.

The present invention relates to scheduling software, and more particularly the manner in which such software operates to generate predicted schedule parameters. Scheduling software is known per se. The functions of scheduling software include the receipt of data entered by a user and relating to resources required to perform a series of inter-related tasks, the ordering or scheduling of tasks in accordance with rules generated by the user, and also the calculation of values of various parameters for the resources for a complete schedule from the data entered by the user for individual tasks. Typically, the most common resource is a total project time calculated from a plurality of time values attributed to individual tasks by the software user, though other resources may be the subject of calculations. The most typical parameter is a total of some kind of resource, although not necessarily an absolute ‘total’ value. For example, in more sophisticated schedules, users are able to enter alternative values for the resources, such as maximum and minimum values and probabilities associated with each, so that the scheduling software may calculate a most probable total value for a particular resource.

The present invention relates to the mathematical basis upon which values for are calculated. According to the present invention, there is provided scheduling software scheduling software adapted to:
receive input data sets for each of a plurality of tasks, each data set including a value for a resource required to perform the task and a rule relating to performance of the task;
having regard to the rules in the data sets, order tasks in accordance with one or more predetermined criteria;
calculate, using each of the values for the resource from individual tasks, a value for a parameter of the resource, wherein the value is calculated upon the basis of a function which is an algebra homomorphism.

A further aspect to the present invention provides method of scheduling consumption of a resource comprising the steps of:
receiving input data sets for each of a plurality of tasks requiring the resource, each data set including a value for a resource required to perform the task and a rule relating to performance of the task;
having regard to the rules in the data sets, ordering tasks in accordance with one or more predetermined criteria; and
calculating, upon the basis of a function which is an algebra homomorphism, using each of the values for the resource from individual tasks, a value for a parameter of the resource.

Embodiments of the present invention will now be described, by way of example, and with reference to the accompanying drawings, in which:

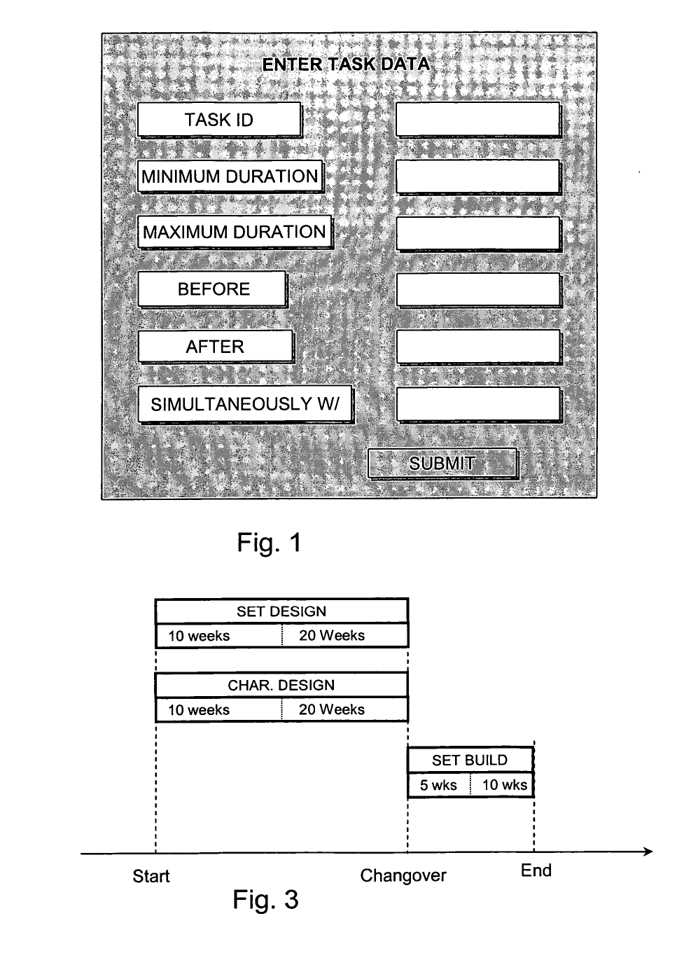

FIG. 1 is an illustration of a graphical user interface for entering data into fictitious scheduling software;

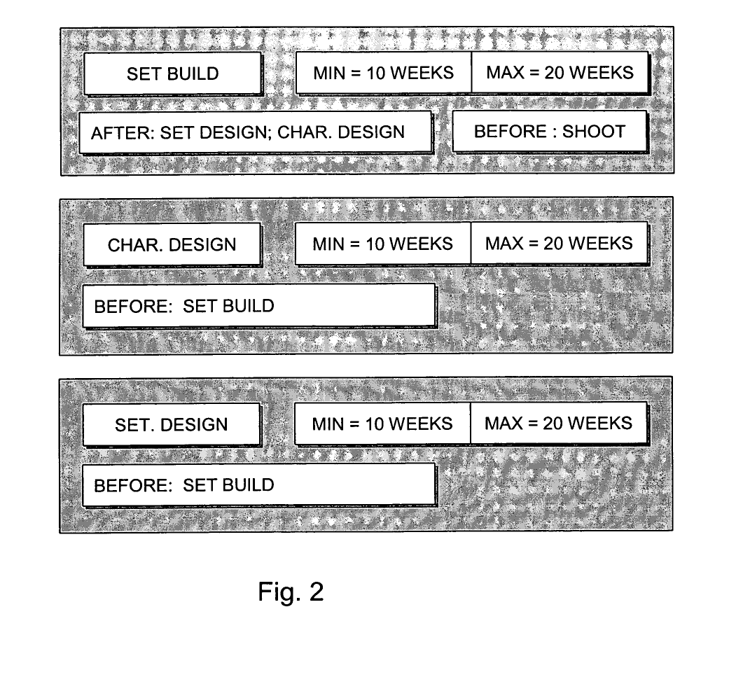

FIG. 2 is an illustration of three data sets entered into the interface of FIG. 1; and

FIG. 3 is a Gant chart illustrating the scheduling of the data sets of FIG. 2.

Referring now to the accompanying drawings, FIG. 1 shows a user interface for a fictitious scheduling software package. The screen illustrated shows the data values which may be entered by a user in order to generate a data set for an individual task. Thus the user is required to enter a task ID, which must be character string unique to the particular task, as well as minimum and maximum values for a resource required to complete the task (in the present example the resource being time). In addition, the user is required to enter at least one rule relating to the performance of the task, and, more particularly relating the performance of the task to the performance of one or more other tasks. In the present example there are three possible rules which may be attributed to each task: that the task in question must not be performed before another particular (and identified by its task ID) task; that it must not be performed after another such particular task; and that it must be performed simultaneously with another particular identified task.

Referring now to FIG. 2, three data sets are shown for three individual tasks required to shoot a film: DESIGN CHAR. (design the characters); DESIGN SET (self explanatory); and SET BUILD (build the set). In the simple example shown, there is only a single resource: time, which is entered as a minimum expected time and a maximum expected time, with an implicit presumption that one is equally as probable an outcome as the other. The data sets have been entered in the order in which they are shown in FIG. 2, that is to say, the SET BUILD data was entered first, followed by the CHAR. DESIGN data and then the DESIGN SET data. It can be seen, however, from the rules of each of the three data sets that both the DESIGN SET and CHAR. DESIGN tasks must be completed before the SET BUILD task. Accordingly, when each of these data sets is received by the scheduling software, the software operates to order the tasks having regard to the rules. Additionally the scheduling software orders the tasks in accordance with one or more predetermined criteria. In the present example there is only one ordering criterion and that is to minimise the total time required, as a result of which, as shown in the Gant chart of FIG. 3, the scheduling software has ordered the tasks such that DESIGN SET and DESIGN CHAR. are performed simultaneously (and, in accordance with the rules in the data sets, before SET BUILD). Other predetermined criteria may be used to schedule the tasks, such as for example: either in addition to, or alternatively to the minimum time criterion, that no two tasks are to be performed simultaneously, either in addition with or alternatively to the minimum time criterion that a predetermined ‘blank’ time interval must be inserted between each task, etc. Thus it can be seen that rules are intrinsic to a data set and absolutely require, regardless of the scheduling criteria, that one or more conditions are met (in the present example with respect to the order in which tasks are performed), whereas scheduling criteria operate to schedule the tasks (in the present example) temporally having regard to the strictures imposed by the rules.

A further function of scheduling software is to calculate a parameter for one or more resources. In the present example the parameter is the total time required to complete all of the scheduled tasks. Given that each of the tasks has two time values, a minimum predicted time and a maximum predicted time, there are, accordingly, several genus of total that may be generated. Examples of such parameters are the maximum total time—which in the present example would be 30 weeks (20 weeks for the performance of DESIGN SET and DESIGN CHAR. added to 10 weeks for the performance of SET BUILD), or minimum total time, which would, in the present example, be 15 weeks. Clearly it is not necessary to use scheduling software to calculate such parameters in the trivial example illustrated, but in the case of a more realistic project involving a large number of interrelated tasks, the calculation of maximum or minimum total time is non-trivial to perform ‘manually’.

Alternative parameters can be calculated. However, in existing scheduling software, the basis upon which this is performed is not always correct. For example DESIGN SET and DESIGN CHAR. are tasks scheduled to be performed simultaneously, each taking a minimum of 10 weeks and (equally probably) a maximum of 20 weeks. Existing scheduling software operates to generate a probable time for completion of both tasks—bearing in mind that both DESIGN CHAR. and DESIGN SET must be completed before commencing SET BUILD—of 15 weeks, by taking a mean for both tasks. This is incorrect. Each of the two tasks has two possible outcomes, so that, when performed simultaneously, there are four possible outcomes as follows:

OUTCOME 1:
DESIGN CHAR.: 10 WEEKS
DESIGN SET: 20 WEEKS
TIME TO SET BUILD: 20 WEEKS

OUTCOME 2
DESIGN CHAR.: 20 WEEKS
DESIGN SET: 10 WEEKS
TIME TO SET BUILD: 20 WEEKS

OUTCOME 3
DESIGN CHAR.: 20 WEEKS
DESIGN SET: 20 WEEKS
TIME TO SET BUILD: 20 WEEKS

OUTCOME 4
DESIGN CHAR.: 10 WEEKS
DESIGN SET: 10 WEEKS
TIME TO SET BUILD: 10 WEEKS

It can be seen that, because both the DESIGN CHAR. and DESIGN SET tasks must be performed before the SET BUILD task, of the four possible outcomes only one will result in the time to the SET BUILD task being 10 weeks. Put another way, the probability of the time to SET BUILD being 10 weeks is not 0.5, which would be the case if the mean time to set build were predicted at 15 weeks, but 0.25; while the probability of the time to set build being 20 weeks is 0.75. Thus, if one were to calculate a mean on the basis of these probabilities, the mean time to SET BUILD would reflect this probability distribution, and would be 17.5 weeks.

It follows that the use of the function ‘mean’ as a basis for calculating a parameter (whether total, or some other parameter) is not valid.

In accordance with the present invention, parameters in scheduling software are calculated on the basis of a function which is an algebra homomorphism. In the case of the simple illustrated example one can consider the four possible outcomes for the time to completion of the two tasks DESIGN SET and DESIGN CHAR. as a probability distribution P:
P(10)=0.5 and P(20)=0.5
in other words, in isolation, each of the times is as probable as the other. Accordingly, if one takes the mean of the two times one obtains the result of 15 weeks. However, when expanded so that the combined effect of the interaction of the two outcomes is taken into account as a joint probability distribution the result looks very different, in that outcomes on a simultaneous pair are as follows:
(10, 20) gives an outcome of 20
(20, 10) gives an outcome of 20
(20, 20) gives an outcome of 20
(10, 10) gives an outcome of 10
   So that the true probability distribution, taking into account the effect of interaction between the two individual results (i.e. 10 weeks or 20 weeks) is given by a new probability distribution Pₛᵢₘ:
   Pₛᵢₘ(10)=0.25 and Pₛᵢₘ(20)=0.75
   Generically, the difference between the two can be illustrated by the following expression:
   f(μ(P), μ(P))≠μ(Pₛᵢₘ P) for all distributions P
   Or, put in simple terms, there is no function f for which the expression above holds true for all distributions P. From this it follows that the mean (μ) is not a valid function upon which to calculate a valid probable parameter total time.

Functions which do display the property of algebra homomorphism include:

(a) Maximum value of a parameter (here ‘total’)

That is, for a given plurality of data sets having alternate values for resources (in this example, time), to calculate the maximum total value of the resource.

(b) Minimum value of parameter (here ‘total’)

For a plurality of data sets having alternate values for resources (again, in this example, time), to calculate the minimum total value of the resource.

(c) Truncation.

A function which omits all of occurrences within a probability distribution beyond a chosen limit. More rigourously expressed:

For some variable resource T, given P take P_{T} (i.e. P truncated)
{P_{T}(t)=P(t)|0≦t≦T}

Yet further functions displaying the property of algebra homomorphism, of which explicit expression is omitted for brevity, including a function in accordance with which samples of a probability distribution are taken in blocks (known sub-sampled truncated).

In the illustrated example the scheduling software generated an order for tasks in the form of actions to be performed in view of the allocation of a resource, which in the examples shown was time. The function of scheduling software is not, however, limited to scheduling the performance of actions but has general applicability to the performance of any activity constrained to any extent by the provision of one or more resources, which may alternatively be one or more of, for example, money, raw materials and personnel. As stated above, the examples shown were, in essence, trivial since they were easily capable of human resolution, and are not intended to be representative of either the complexity of the number and interactive relationship between the task, nor of the number of resources; the scheduling of tasks which, together, are dependent for their performance upon a plurality of resources is also possible.

Further, in the example illustrated (and further examples discussed herein) the parameter calculated was the total—whether most probable, maximum or minimum. In a real-life scenario, the calculation of other parameters is equally possible, such as for example parameters based on a derivative of some other quantity, such rate of consumption of one resource with respect to some other quantity (which may be time, or some other resource, for example), for example. The invention is not limited to the calculation of a single parameter, and several parameters may be calculated, each depending upon more than one interrelated resource, as the case requires.

1. A computer-readable medium storing therein scheduling software which, when executed by a computer, causes the computer to:
receive input data sets for each of a plurality of tasks, each data set including a value for a resource required to perform the task and a rule relating to performance of the task;
having regard to the rules in the data sets, order tasks in accordance with one or more predetermined criteria; and
calculate, using each of the values for the resource from individual tasks, a value for a parameter of the resource, wherein the value is calculated upon the basis of a function which is an algebra homomorphism.

2. The computer-readable medium according to claim 1 wherein the parameter is a total value of the resource required for the performance of all the tasks.

3. The computer-readable medium according to claim 1 wherein the parameter is a rate of consumption of a resource with respect to some other resource.

4. The computer-readable medium according to claim 1 wherein the resource is time.

5. The computer-readable medium according to claim 1 wherein the algebra homomorphism is selected from the group consisting of:
maximum possible parameter value;
minimum possible parameter value; and
function truncating a probability distribution of usage of a resource.

6. A method of scheduling consumption of a resource, said method comprising of:
receiving input data sets for each of a plurality of tasks requiring the resource, each data set including a value for a resource required to perform the task and a rule relating to performance of the task;
having regard to the rules in the data sets, ordering tasks in accordance with one or more predetermined criteria; and
calculating, upon the basis of a function which is an algebra homomorphism, using each of the values for the resource from individual tasks, a value for a parameter of the resource.

7. The method according to claim 6, wherein the parameter is a total value of the resource required.

8. The method according to claim 6, wherein the parameter is a rate of consumption of a resource with respect to some other resource.

9. The method according to claim 6, wherein the resource is time.

10. The method according to claim 6, wherein the algebra homomorphism is selected from the group consisting of:
maximum possible parameter value;
minimum possible parameter value;
function truncating a probability distribution of usage of a resource.

11. An apparatus for scheduling consumption of a resource, said apparatus comprising:
receiving means for receiving input data sets for each of a plurality of tasks requiring the resource, each data set including a value for a resource required to perform the task and a rule relating to performance of the task;
ordering means for, having regard to the rules in the data sets, ordering tasks in accordance with one or more predetermined criteria; and
calculating means for calculating, upon the basis of a function which is an algebra homomorphism, using each of the values for the resource from individual tasks, a value for a parameter of the resource.

12. The apparatus according to claim 11, wherein the parameter is a total value of the resource required.

13. The apparatus according to claim 11, wherein the parameter is a rate of consumption of a resource with respect to some other resource.

14. The apparatus according to claim 11, wherein the resource is time.

15. The apparatus according to claim 11, wherein the algebra homomorphism is selected from the group consisting of:
maximum possible parameter value;
minimum possible parameter value; and
function truncating a probability distribution of usage of a resource.

16. A computer system, comprising:
a processor; and
a memory coupled to said processor, said memory having stored therein sequences of instructions which, when executed by said processor, cause said processor to perform the method of claim 6.

17. A processor arrangement configured to perform the method of claim 6.

18. A computer system configured to schedule consumption of a resource, said computer system comprising:
a receiving unit configured to receive input data sets for each of a plurality of tasks requiring the resource, each data set including a value for a resource required to perform the task and a rule relating to performance of the task;
an ordering unit configured to, having regard to the rules in the data sets, order tasks in accordance with one or more predetermined criteria; and
a calculating unit configured to calculate, upon the basis of a function which is an algebra homomorphism, using each of the values for the resource from individual tasks, a value for a parameter of the resource.

19. The computer system of claim 18, wherein at least one of said receiving unit, ordering unit and calculating unit is implemented by a programmed processor.

20. The computer system of claim 18, wherein at least one of said receiving unit, ordering unit and calculating unit is implemented by a hard-wired logic circuit.
